(19) United States
(12) Patent Application Publication
(10) Pub. No.: US 2026/0341874 A1
(43) Pub. Date: Oct. 29, 2026

(54) VEHICLE BATTERY SYSTEM AND VEHICLE INCLUDING SAME

(71) Applicant: HYUNDAI MOBIS CO., LTD., Seoul (KR)

(72) Inventors: Min Kyun NA, Seoul (KR); Byung Don KWON, Seoul (KR); Hyuk Geun SONG, Seoul (KR)

(73) Assignee: HYUNDAI MOBIS CO., LTD., Seoul (KR)

(21) Appl. No.: 19/558,728

(22) Filed: Mar. 6, 2026

(30) Foreign Application Priority Data
Apr. 25, 2025 (KR) 10-2025-0054691

(51) Int. Cl. H01M 50/242; B60K 1/04; H01M 50/249; H01M 50/262

(52) U.S. Cl. CPC H01M 50/242; B60K 1/04; H01M 50/249; H01M 50/262; H01M 2220/20

(57) ABSTRACT

A vehicle battery system, a vehicle and a battery case thereof are provided. The vehicle battery system includes a battery case including an upper case and a lower case, and a bracket assembly connecting the upper case and the lower case, and fastening the battery case to a vehicle body. The bracket assembly includes a fastening bracket fixed to the lower case and fastened to the vehicle body, and a motion-absorbing bracket connecting and supporting the upper case and the fastening bracket, and absorbing motion of the battery case.

### CROSS-REFERENCE TO RELATED APPLICATION

This application claims priority to and the benefit under 35 USC § 119(a) of Korean Patent Application No. 10-2025-0054691, filed on Apr. 25, 2025, in the Korean Intellectual Property Office, the entire disclosure of which is hereby incorporated by reference for all purposes.

### BACKGROUND

### 1. Field

The present disclosure relates to a vehicle battery system including a bracket assembly for fastening to a vehicle body, and a vehicle including the same.

### 2. Description of the Related Art

With the recent increase in demand for eco-friendly vehicles, the design and installation technology of battery systems used in electric vehicles is gaining importance. These vehicle battery systems are typically installed under the vehicle body and secured by fastening to the vehicle body.

Generally, the rigidity of a battery system is significantly affected by the assembly location in the vehicle body and the number of fastening points. While a greater number of fastening points improves durability against external shocks and vibrations, securing a sufficient number of fastening points is often difficult due to vehicle structural layout and space constraints.

Due to these limitations, battery systems may be designed to minimize the number of fastening points, which can increase structural vulnerability to external vibrations and shocks. For example, if external vibrations or shocks are repeatedly applied, a battery case may oscillate, potentially causing damage such as cracks or breakage at a mounting area.

Therefore, there is a need to develop technology that can effectively suppress motion of a battery system caused by external forces under conditions in which fastening points are limited, while taking into account vehicle layout constraints.

### SUMMARY

The present disclosure has been conceived in consideration of the above issues, and an object of the present disclosure is to provide a battery system structure capable of effectively suppressing battery system motion and resulting structural damage due to external forces such as external vibration and impact even when the number of fastening points between a battery system and a vehicle body is limited due to structural constraints of the vehicle.

The technical objects to be achieved by the present disclosure are not limited to the technical objects mentioned above, and other technical objects not mentioned will be clearly understood by those skilled in the art from the following description.

In a general aspect, a vehicle battery system includes: a battery case including an upper case and a lower case; and a bracket assembly connecting the upper case and the lower case, and configured to fasten the battery case to a vehicle body, wherein the bracket assembly includes: a fastening bracket fixed to the lower case and fastened to the vehicle body; and a motion-absorbing bracket connecting and supporting the upper case and the fastening bracket, and configured to absorb motion of the battery case.

The motion-absorbing bracket may include a first connecting portion having a fastening surface with respect to the upper case, an extension portion bent from an end of the first connecting portion and extending toward the outside of the battery case, and a second connecting portion bent from an end of the extension portion to form a fastening surface with respect to the fastening bracket.

The vehicle battery system may further include a first reinforcing bracket installed on a lower surface of the motion-absorbing bracket, wherein the first reinforcing bracket is configured to reinforce the rigidity of the motion-absorbing bracket.

The first reinforcing bracket may include a horizontal reinforcing portion supporting a bottom surface of the extension portion, and a vertical reinforcing portion extending and bent from the horizontal reinforcing portion, and supporting a bottom surface of the second connecting portion.

The fastening bracket may include: a first fixing portion having a fixing surface to be secured to a bottom surface of the lower case; a fastening portion bent from an end of the fixing portion and extending upward, and fastened to the second connecting portion of the motion-absorbing bracket; and a second fixing portion bent from an end of the fastening portion and forming a fastening surface with respect to a bottom surface of the vehicle body.

The vehicle battery system may include a second reinforcing bracket installed on upper surfaces of the extension portion of the motion-absorbing bracket and the first fixing portion, and the fastening portion of the fastening bracket.

The second reinforcing bracket may include: a first reinforcing portion supported by and fixed to the upper surface of the extension portion; a vertical connecting portion bent from an end of the first reinforcing portion and extending upward; and a second reinforcing portion bent and extending from an end of the vertical connecting portion, the second reinforcing portion supported and fixed to the upper surface of the first fixing portion.

The upper case may be provided with a fixed bracket connected to the motion-absorbing bracket.

The bracket assembly may include: at least one first bracket assembly installed at the front portion of the battery case; and at least one second bracket assembly installed at the rear portion of the battery case.

In another general aspect, a vehicle includes: a vehicle body having a battery mounting space; and a battery system installed in the battery mounting space and configured to supply power to the vehicle, wherein the battery system includes a battery case including an upper case and a lower case, and a bracket assembly connecting the upper case and the lower case and fastening the battery case to the vehicle body, and wherein the bracket assembly includes a fastening bracket fixed to the lower case and fastened to the vehicle body, and a motion-absorbing bracket connecting and supporting the upper case and the fastening bracket, and absorbing motion of the battery case.

In yet another general aspect, a battery assembly for a vehicle includes: a battery; a battery case configured to house the battery and including an upper case and a lower case; and a bracket assembly connecting the upper case and the lower case, and configured to fasten the battery case to a battery mounting space of a vehicle body, wherein the bracket assembly includes a fastening bracket fixed to the lower case and fastened to the vehicle body, and a motion-absorbing bracket connecting and supporting the upper case and the fastening bracket, and configured to absorb motion forces of the battery case.

The motion-absorbing bracket may include: a first connecting portion having a fastening surface with respect to the upper case; an extension portion bent from an end of the first connecting portion and extending toward the outside of the battery case; and a second connecting portion bent from an end of the extension portion to form a fastening surface with respect to the fastening bracket.

The battery assembly may include a first reinforcing bracket installed on a lower surface of the motion-absorbing bracket, wherein the first reinforcing bracket is configured to reinforce the rigidity of the motion-absorbing bracket.

According to the embodiments of the present disclosure, a bracket assembly structure in which the motion-absorbing bracket is installed between the fastening bracket and the upper case to absorb the motion of the battery case can be effectively used to minimize the motion of the battery system and resulting structural damage due to external force such as vibration and impact, even when fastening points of the battery case need to be minimized due to structural constraints of a vehicle.

This reduction in the motion of the battery system can increase the natural frequency of the battery system, thereby securing the mechanical rigidity of the battery system.

Furthermore, according to the embodiments of the present disclosure, the battery system can be more securely installed within a limited fastening area, thereby reducing the number of fastening points and providing economical manufacturing costs.

### BRIEF DESCRIPTION OF THE DRAWINGS

FIG. 1 is a perspective view of a vehicle battery system according to an embodiment of the present disclosure.

FIGS. 2 and 3 are diagrams illustrating configurations of a first bracket assembly and a second bracket assembly illustrated in FIG. 1.

FIG. 4 is a side view of the vehicle battery system illustrated in FIG. 1.

FIG. 5 is a diagram illustrating the vehicle battery system illustrated in FIG. 1 installed in a vehicle body.

FIG. 6 is a diagram illustrating a configuration of a bracket assembly according to another embodiment of the present disclosure.

FIG. 7 is a diagram illustrating a configuration of a bracket assembly according to another embodiment of the present disclosure.

### DETAILED DESCRIPTION

The present disclosure is susceptible to various modifications and embodiments, and specific embodiments are illustrated in the drawings and described in detail in the detailed description. However, this is not intended to limit the present disclosure to specific embodiments, but rather to encompass all modifications, equivalents, and alternatives within the spirit and technical scope of the present disclosure. In describing the present disclosure, detailed descriptions of related known technologies will be omitted if they are deemed to obscure the gist of the present disclosure

Terms such as “first”, “second”, and the like may be used to describe various components, but these components should not be limited by these terms. These terms are used solely to distinguish one component from another.

The terms used in this application are solely used to describe specific embodiments and do not limit the present disclosure. The singular expressions include plural expressions unless the context clearly indicates otherwise. In this application, it will be understood that the terms “comprise” and “include” specify the presence of stated features, numbers, steps, operations, elements, components, or combinations thereof, but do not preclude the presence or addition of one or more other features, numbers, steps, operations, elements, components, or combinations thereof.

Hereinafter, embodiments of a vehicle battery system according to the present disclosure and a vehicle equipped with the same will be described in detail with reference to the accompanying drawings. In the following description, identical or corresponding components are assigned the same reference numerals, and redundant descriptions thereof will be omitted.

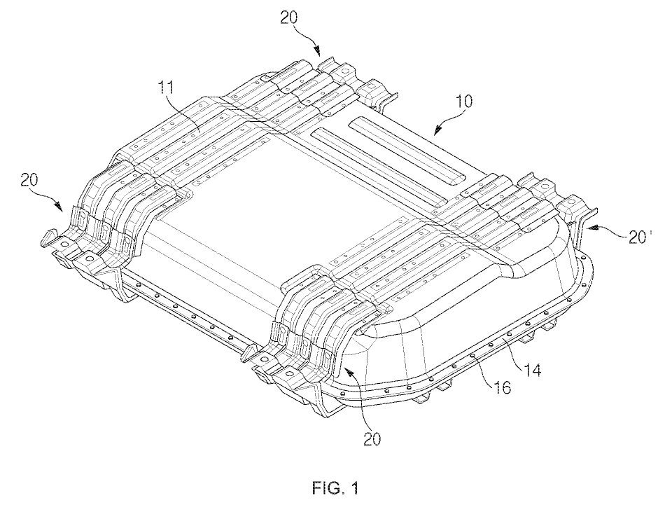

FIG. 1 is a perspective view of a vehicle battery system according to an embodiment of the present disclosure.

As illustrated in FIG. 1, the vehicle battery system according to the present embodiment includes a battery case 10 and bracket assemblies 20 and 20’.

The battery case 10 has a battery accommodation space inside thereof and includes an upper case 11 and a lower case 12 that are joined to each other. Flanges 14 may be formed on the edges of the upper case 11 and the lower case 12 (refer to FIG. 3), and the flanges 14 may be joined to each other by fastening means, for example, bolts and nuts. A plurality of fastening means may be provided at regular intervals on each flange 14.

The bracket assemblies 20 and 20’ connect the upper case 11 and the lower case 12 and fasten the battery case 10 to a vehicle body 1. The bracket assemblies 20 and 20’ may include one or more first bracket assemblies 20 installed at the front of the battery case 10 and one or more second bracket assemblies 20’ installed at the rear of the battery case 10. According to the present embodiment, a configuration in which the first bracket assemblies 20 and the second bracket assemblies 20’ are installed as a pair at the front and rear of the battery case 10 is exemplified.

The first bracket assemblies 20 and the second bracket assemblies 20’ may have the same configuration, but depending on the shape of the vehicle body 1, the shapes of some of the first bracket assemblies 20 and the second bracket assemblies 20’ may be different.

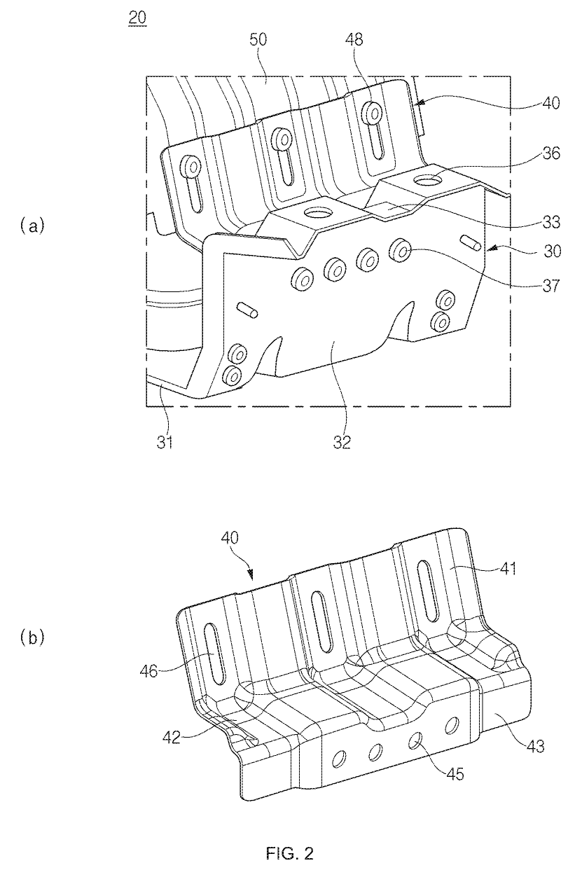

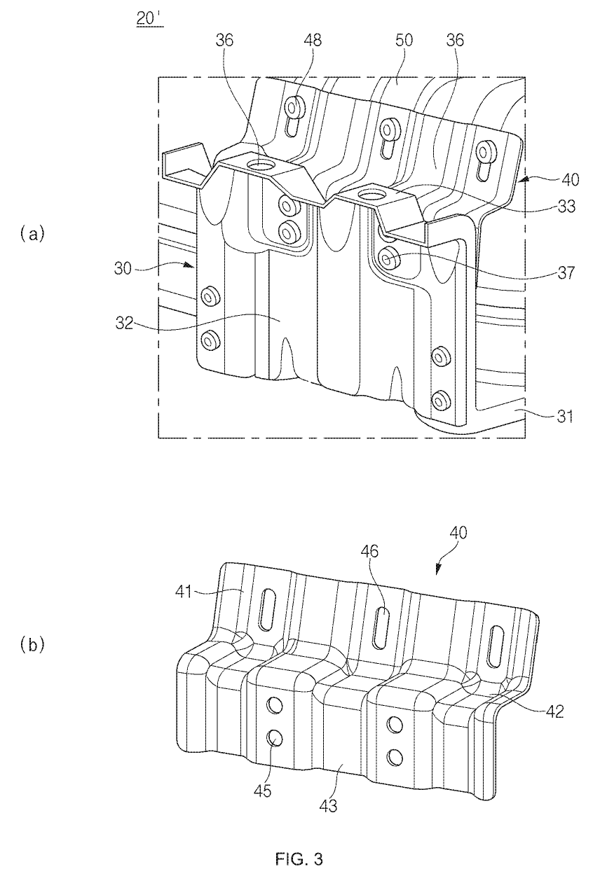

FIGS. 2 and 3 are diagrams illustrating configurations of the first and second bracket assemblies illustrated in FIGS. 1, and 4 is a side view of the vehicle battery system illustrated in FIG. 1.

FIG. 2, part (a) illustrates the configuration of the first bracket assembly 20 as viewed from the front of the battery case 10, and FIG. 2, part (b) separately illustrates a motion-absorbing bracket 40 illustrated in FIG. 2, part (a). FIG. 3, part (a) illustrates the configuration of the second bracket assembly 20’ as viewed from the rear of the battery case 10, and FIG. 3, part (b) separately illustrates the motion-absorbing bracket 40 illustrated in FIG. 3, part (a).

For reference, the components constituting the first bracket assembly 20 and the second bracket assembly 20’ have the same functional configuration. In the present embodiment, as described above, the components are formed in different shapes depending on the shape of the vehicle body 1.

As illustrated in FIGS. 2-4, the bracket assemblies 20 and 20’ includes a fastening bracket 30 and the motion-absorbing bracket 40.

The fastening bracket 30 is configured to be fixed to the lower case 12 and fastened to the vehicle body 1. The fastening bracket 30 may include a first fixing portion 31 having a fixing surface to be secured to the bottom surface of the lower case 12, a fastening portion 32 that is bent from an end of the fixing portion and extends upward, and a second fixing portion 33 that is bent from an end of the fastening portion 32 and forms a fastening surface with respect to the bottom surface of the vehicle body 1.

The fixing surface of the first fixing portion 31 may be joined to the bottom surface of the lower case 12 by welding or the like, and a fastening means 37 (for example, a bolt and a nut) for fastening to the motion-absorbing bracket 40 may be fastened to the fastening portion 32. The second fixing portion 33 is formed to extend outward from the bent portion of the fastening portion 32, and a fastening hole 36 for fastening the fastening means may be formed in the fastening surface.

The motion-absorbing bracket 40 connects and supports the upper case 11 and the fastening bracket 30, and is configured to absorb the motion of the battery case 10.

The motion-absorbing bracket 40 may include a first connecting portion 41 having a fastening surface with respect to the upper case 11, an extension portion 42 that is bent from an end of the first connecting portion 41 and extends outwardly from the battery case 10, and a second connecting portion 43 that is bent from an end of the extension portion 42 and forms a fastening surface with respect to the fastening bracket 30.

A fastening hole 46 for fastening a fastening means 48 (for example, a bolt) is formed in the fastening surface of the first connecting portion 41, and the fastening hole 46 may have an elongated hole shape to allow adjustment of the coupling position of the fastening means 48. The extension portion 42 extends from the bent portion toward the fastening bracket 30, and the second connecting portion 43 may be bent downward from the end of the extension portion 42. The fastening surface of the second connecting portion 43 is connected by making surface contact with the fastening portion 32 of the fastening bracket 30, and a fastening hole 45 to which the fastening means 37 of the fastening bracket 30 is fastened may be formed in the fastening surface of the second connecting portion 43.

Meanwhile, a fixed bracket 50 fastened to the motion-absorbing bracket 40 may be provided on the upper case 11. The fixed bracket 50 may have a shape corresponding to the outer surface of the upper case 11 and may be fixed to the upper case 11 through a joining method such as welding. In the case of a structure in which the fixed bracket 50 is provided on the upper case 11, the first connecting portion 41 of the motion-absorbing bracket 40 has a shape corresponding to the outer surface of the fixed bracket 50, and the first connecting portion 41 of the motion-absorbing bracket 40 may be fastened to the fixed bracket 50.

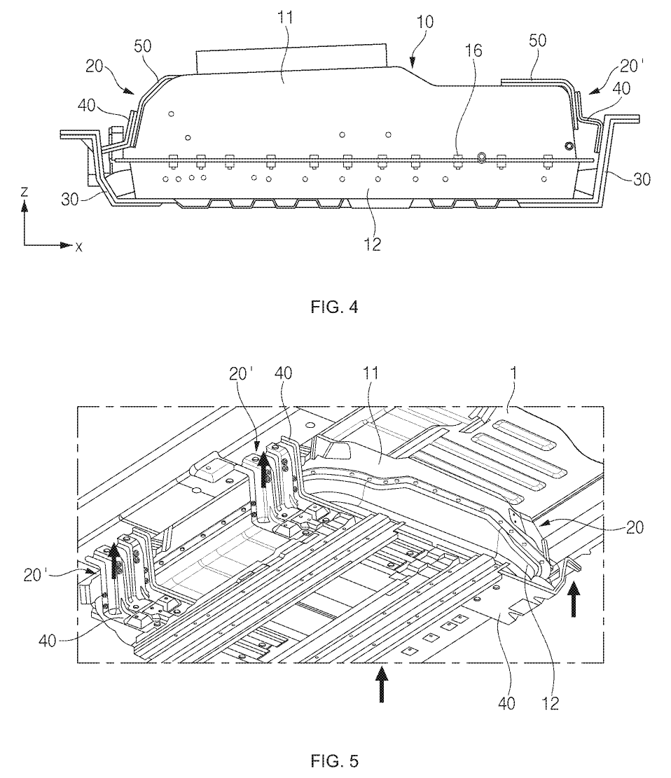

FIG. 5 is a diagram illustrating the vehicle battery system illustrated in FIG. 1 installed in the vehicle body 1 of the vehicle.

As illustrated in FIG. 5, the vehicle battery system may be assembled in a battery mounting space provided at the bottom of the vehicle body 1 in an upward direction (i.e., in the direction of the arrow in FIG. 5).

After installing the battery case 10 in an upward direction, the battery case 10 may be fastened to the vehicle body 1 via the fastening brackets 30 of the bracket assemblies 20 and 20’. In a state in which the second fixing portion 33 of the fastening bracket 30 is in contact with the bottom surface of the vehicle body 1, the fastening bracket 30 may be fixed to the bottom surface of the vehicle body 1 using fastening members such as bolts.

According to the present embodiment, the motion-absorbing bracket 40 can provide a joining force for joining the upper case 11 and the lower case 12 between the fastening bracket 30 and the upper case 11 and absorb the displacement(or vibration) of the battery case 10 due to external force such as external vibration and impacts, for example, oscillations along the x-axis and z-axis directions (refer to FIG. 4), thereby minimizing structural damage, such as breakage, at the fastening portion assembled with the vehicle body 1. By reducing the motion of the battery case 10 due to external force in this way, the natural frequency of the battery system can be increased, thereby ensuring the mechanical rigidity of the battery system.

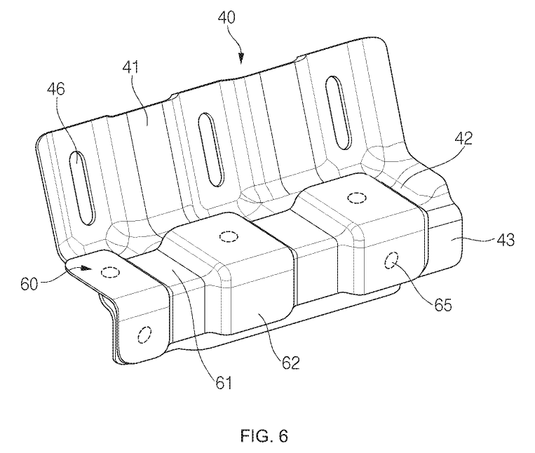

FIG. 6 is a diagram illustrating the configurations of the bracket assemblies 20 and 20’ according to another embodiment of the present disclosure. For reference, FIG. 6 illustrates only the motion-absorbing bracket 40 of the bracket assemblies 20 and 20’, excluding the fastening bracket 30.

As illustrated in FIG. 6, according to the bracket assemblies 20 and 20’ of the present embodiment, a first reinforcing bracket 60 is additionally provided on the bottom surface of the motion-absorbing bracket 40. The first reinforcing bracket 60 reinforces the rigidity of the motion-absorbing bracket 40 and may be joined to the motion-absorbing bracket 40 by welding or the like.

The first reinforcing bracket 60 may include a horizontal reinforcing portion 61 that supports the bottom surface of the extension portion 42 and a vertical reinforcing portion 62 that is bent and extends from the horizontal reinforcing portion 61. The vertical reinforcing portion 62 supports the bottom surface of the second connecting portion 43 of the motion-absorbing bracket 40. The horizontal reinforcing portion 61 and the vertical reinforcing portion 62 may be joined to the extension portion 42 and the second connecting portion 43 of the motion-absorbing bracket 40, respectively. For reference, the dotted lines in FIG. 6 denotes weld spots 65 between the first reinforcing bracket 60 and the motion-absorbing bracket 40.

According to the present embodiment, by additionally installing the first reinforcing bracket 60 at a position where the load of the motion-absorbing bracket 40 is significantly applied, it is possible to further improve the motion-absorbing performance of the motion-absorbing bracket 40.

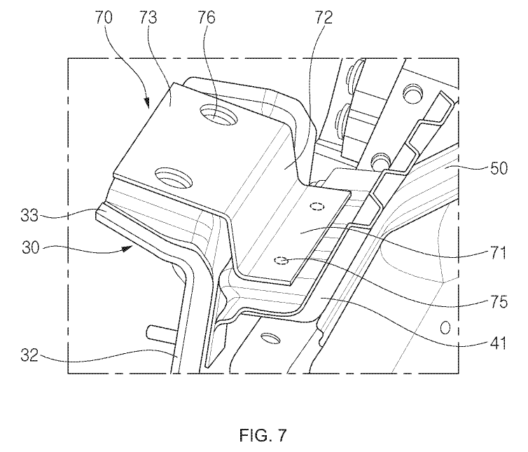

FIG. 7 is a diagram illustrating the configurations of the bracket assemblies 20 and 20’ according to another embodiment of the present disclosure, and illustrates a modified example of the reinforcing structure of the bracket assemblies 20 and 20’ in FIG. 6.

According to the present embodiment, a second reinforcing bracket 70 is additionally provided in the bracket assemblies 20 and 20’, and the second reinforcing bracket 70 is installed on the outer surfaces (upper surfaces) of the extension portion 42 of the motion-absorbing bracket 40 and the first fixing portion 31 and the fastening portion 32 of the fastening bracket 30.

The second reinforcing bracket 70 may include a first reinforcing portion 71 that is supported by and fixed to the upper surface of the extension portion 42 of the motion-absorbing bracket 40, a vertical connecting portion 72 that is bent from an end of the first reinforcing portion 71 and extends upward, and a second reinforcing portion 73 that is bent and extends from an end of the vertical connecting portion 72. The second reinforcing portion 73 is supported and fixed to the upper surface of the first fixing portion 31 of the fastening bracket 30, and a fastening hole 76 for fastening a fastening means may be formed on the support surface of the second reinforcing portion 73. The second reinforcing bracket 70 may be secured to the motion-absorbing bracket 40 by joining the first reinforcing portion 71 to the extension portion 42 of the motion-absorbing bracket 40. The part indicated by the dotted line in FIG. 7 indicates a welding point between the second reinforcing bracket 70 and the motion-absorbing bracket 40.

In this manner, after joining the second reinforcing bracket 70 to the upper surface of the motion-absorbing bracket 40, the fastening bracket 30 and the second reinforcing bracket 70 can be assembled together by fastening the same to the bottom surface of the vehicle body 1. The embodiment can also reinforce the rigidity of the motion-absorbing bracket 40 and the fastening bracket 30, and by fastening the second reinforcing bracket 70 together with the fastening bracket 30, improve the structural stability of the reinforcement structure.

Although the present disclosure has been described above with reference to specific embodiments, it will be understood by those skilled in the art that various modifications and changes may be made to the present disclosure without departing from the spirit and scope of the present disclosure as set forth in the claims below.

What is claimed is:

1. A vehicle battery system comprising:
a battery case including an upper case and a lower case; and
a bracket assembly connecting the upper case and the lower case, and configured to fasten the battery case to a vehicle body,
wherein the bracket assembly comprises:
a fastening bracket fixed to the lower case and fastened to the vehicle body; and
a motion-absorbing bracket connecting and supporting the upper case and the fastening bracket, and configured to absorb motion of the battery case.

2. The vehicle battery system of claim 1, wherein the motion-absorbing bracket comprises:
a first connecting portion having a fastening surface with respect to the upper case;
an extension portion bent from an end of the first connecting portion and extending toward the outside of the battery case; and
a second connecting portion bent from an end of the extension portion to form a fastening surface with respect to the fastening bracket.

3. The vehicle battery system of claim 2, further comprising:
a first reinforcing bracket installed on a lower surface of the motion-absorbing bracket,
wherein the first reinforcing bracket is configured to reinforce the rigidity of the motion-absorbing bracket.

4. The vehicle battery system of claim 3, wherein the first reinforcing bracket comprises:
a horizontal reinforcing portion supporting a bottom surface of the extension portion; and
a vertical reinforcing portion extending and bent from the horizontal reinforcing portion, and supporting a bottom surface of the second connecting portion.

5. The vehicle battery system of claim 2, wherein the fastening bracket comprises:
a first fixing portion having a fixing surface to be secured to a bottom surface of the lower case;
a fastening portion bent from an end of the fixing portion and extending upward, and fastened to the second connecting portion of the motion-absorbing bracket; and
a second fixing portion bent from an end of the fastening portion and forming a fastening surface with respect to a bottom surface of the vehicle body.

6. The vehicle battery system of claim 5, further comprising:
a second reinforcing bracket installed on upper surfaces of the extension portion of the motion-absorbing bracket and the first fixing portion, and the fastening portion of the fastening bracket.

7. The vehicle battery system of claim 6, wherein the second reinforcing bracket comprises:
a first reinforcing portion supported by and fixed to the upper surface of the extension portion;
a vertical connecting portion bent from an end of the first reinforcing portion and extending upward; and
a second reinforcing portion bent and extending from an end of the vertical connecting portion, the second reinforcing portion supported and fixed to the upper surface of the first fixing portion.

8. The vehicle battery system of claim 1, wherein the upper case is provided with a fixed bracket connected to the motion-absorbing bracket.

9. The vehicle battery system of claim 1, wherein the bracket assembly comprises:
at least one first bracket assembly installed at the front portion of the battery case; and
at least one second bracket assembly installed at the rear portion of the battery case.

10. A vehicle comprising:
a vehicle body having a battery mounting space; and
a battery system installed in the battery mounting space and configured to supply power to the vehicle,
wherein the battery system comprises:
a battery case including an upper case and a lower case; and
a bracket assembly connecting the upper case and the lower case and fastening the battery case to the vehicle body, and
wherein the bracket assembly comprises:
a fastening bracket fixed to the lower case and fastened to the vehicle body; and
a motion-absorbing bracket connecting and supporting the upper case and the fastening bracket, and absorbing motion of the battery case.

11. A battery assembly for a vehicle, the battery assembly comprising:
a battery;
a battery case configured to house the battery and including an upper case and a lower case; and
a bracket assembly connecting the upper case and the lower case, and configured to fasten the battery case to a battery mounting space of a vehicle body,
wherein the bracket assembly comprises:
a fastening bracket fixed to the lower case and fastened to the vehicle body; and
a motion-absorbing bracket connecting and supporting the upper case and the fastening bracket, and configured to absorb motion forces of the battery case.

12. The battery assembly of claim 11, wherein the motion-absorbing bracket comprises:
a first connecting portion having a fastening surface with respect to the upper case;
an extension portion bent from an end of the first connecting portion and extending toward the outside of the battery case; and
a second connecting portion bent from an end of the extension portion to form a fastening surface with respect to the fastening bracket.

13. The battery assembly of claim 12, further comprising:
a first reinforcing bracket installed on a lower surface of the motion-absorbing bracket,
wherein the first reinforcing bracket is configured to reinforce the rigidity of the motion-absorbing bracket.
